(19) United States
(12) Patent Application Publication
(10) Pub. No.: US 2022/0410474 A1
(43) Pub. Date: Dec. 29, 2022

(54) ADDITIVE MANUFACTURING SYSTEM

(71) Applicant: Continuous Composites Inc., Coeur d'Alene, ID (US)

(72) Inventor: Nathan Andrew Stranberg, Post Falls, ID (US)

(73) Assignee: Continuous Composites Inc., Coeur d'Alene, ID (US)

(21) Appl. No.: 17/659,948

(22) Filed: Apr. 20, 2022

Related U.S. Application Data
(60) Provisional application No. 63/202,906, filed on Jun. 29, 2021.

(51) Int. Cl. B29C 64/165; B33Y 10/00; B33Y 30/00; B29C 64/386; B33Y 50/00

(52) U.S. Cl. CPC B29C 64/165; B33Y 10/00; B33Y 30/00; B29C 64/386; B33Y 50/00; B29K 2307/04

(57) ABSTRACT

A method is disclosed for additively manufacturing a structure. The method may include discharging a composite material, including a reinforcement and a matrix, from a print head, and moving the print head during discharging to form the structure from the composite material. The method may further include exposing the composite material during discharging to a cure energy to trigger the matrix to harden, and selectively adding a filler to the composite material to cause the composite material to increase a temperature achieved when the composite material is exposed to the cure energy.

### RELATED APPLICATION

This application is based on and claims the benefit of priority from U.S. Provisional Application No. 63/202,906 that was filed on Jun. 29, 2021, the contents of which are expressly incorporated herein by reference.

### TECHNICAL FIELD

The present disclosure relates generally to a manufacturing system and, more particularly, to a system for additively manufacturing an object.

### BACKGROUND

Continuous fiber 3D printing (a.k.a., CF3D®) involves the use of continuous fibers embedded within material discharging from a moveable print head. A matrix is supplied to the print head and discharged (e.g., extruded and/or pultruded) along with one or more continuous fibers also passing through the same head at the same time. The matrix can be a traditional thermoplastic, a liquid thermoset (e.g., an energy-curable single- or multi-part resin), or a combination of any of these and other known matrixes. Upon exiting the print head, a cure enhancer (e.g., a UV light, a laser, an ultrasonic emitter, a heat source, a catalyst supply, or another energy source) is activated to initiate, enhance, and/or complete curing of the matrix. This curing occurs almost immediately, allowing for unsupported structures to be fabricated in free space. When fibers, particularly continuous fibers, are embedded within the structure, a strength of the structure may be multiplied beyond the matrix-dependent strength. An example of this technology is disclosed in U.S. Pat. No. 9,511,543 that issued to TYLER on Dec. 6, 2016.

Although CF3D® provides for increased strength, compared to manufacturing processes that do not utilize continuous fiber reinforcement, care must be taken to ensure proper wetting of the fibers with the matrix, proper compaction of the matrix-coated fibers after discharge, and proper curing of the compacting material. An exemplary print head that provides for at least some of these functions is disclosed in U.S. Patent Publication 2021/0260821 that was filed on Feb. 24, 2021 (“the '821 publication”).

While the print head of the '821 publication may be functionally adequate for many applications, it may be less than optimal. For example, the print head may lack accuracy in compaction and/or curing that is required for other applications. The disclosed system is directed at addressing one or more of these issues and/or other problems of the prior art.

### SUMMARY

In one aspect, the present disclosure is directed to method of additively manufacturing a structure. The method may include discharging a composite material, including a reinforcement and a matrix, from a print head, and moving the print head during discharging to form the structure from the composite material. The method may further include exposing the composite material during discharging to a cure energy to trigger the matrix to harden, and selectively adding a filler to the composite material to cause the composite material to increase a temperature achieved when the composite material is exposed to the cure energy.

In another aspect, the present disclosure is directed to another method of additively manufacturing a structure. The method may include heating a reinforcement at a location inside of a print head, wetting the heated reinforcement with a matrix to form a composite material, and discharging the composite material from the print head. The method may also include moving the print head during discharging to form the structure, and exposing the discharging composite material to a cure energy to trigger the matrix to harden.

In another aspect, the present disclosure is directed to another method of additively manufacturing a structure. The method may include discharging a composite material, including a reinforcement and a matrix, from print head, and moving the print head during discharging to form the structure. The method may also include exposing the composite material to a first cure energy at a first location during discharging, and exposing the composite material to a second cure energy at a second location downstream of the first location. The second cure energy may be greater than the first cure energy.

In another aspect, the present disclosure is directed to a system for additively manufacturing a structure. The system may include a print head configured to discharge a composite material, including a reinforcement and a matrix, and a support configured to move the print head during discharging to form the structure from the composite material. The system may also include a cure enhancer configured to expose the composite material during discharging to a cure energy to trigger the matrix to harden, and a supply configured to selectively add a filler to the composite material to cause the composite material to increase a temperature achieved when the composite material is exposed to the cure energy.

### BRIEF DESCRIPTION OF THE DRAWINGS

FIG. 1 is an isometric illustration of an exemplary disclosed additive manufacturing system; and

FIG. 2 is a side-view illustration of an exemplary disclosed print head that may be used in conjunction with the system of FIG. 1; and

FIG. 3 is a diagrammatic illustration of exemplary disclosed portion of the print head of FIG. 2.

### DETAILED DESCRIPTION

The term “about” as used herein serves to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1% of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

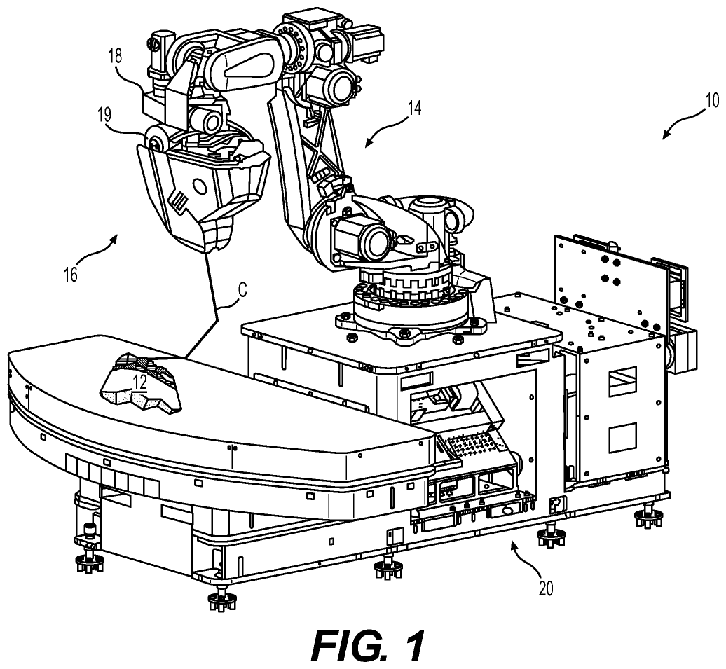

FIG. 1 illustrates an exemplary system 10, which may be used to manufacture a composite structure 12 having any desired shape, size, configuration, and/or material composition. System 10 may include at least a support 14 and a head 16. Head 16 may be coupled to and moveable by support 14 during discharge of a composite material (shown as C). In the disclosed embodiment of FIG. 1, support 14 is a robotic arm capable of moving head 16 in multiple directions during fabrication of structure 12. Support 14 may alternatively embody a gantry (e.g., a floor gantry, an overhead or bridge gantry, a single-post gantry, etc.) or a hybrid gantry/arm also capable of moving head 16 in multiple directions during fabrication of structure 12. Although support 14 is shown as being capable of moving head 16 about multiple (e.g., six) axes, it is contemplated that another type of support 14 capable of moving head 16 (and/or other tooling relative to head 16) in the same or a different manner could also be utilized. In some embodiments, a drive or coupler 18 may mechanically join head 16 to support 14 and include components that cooperate to move portions of and/or supply power and/or materials to head 16.

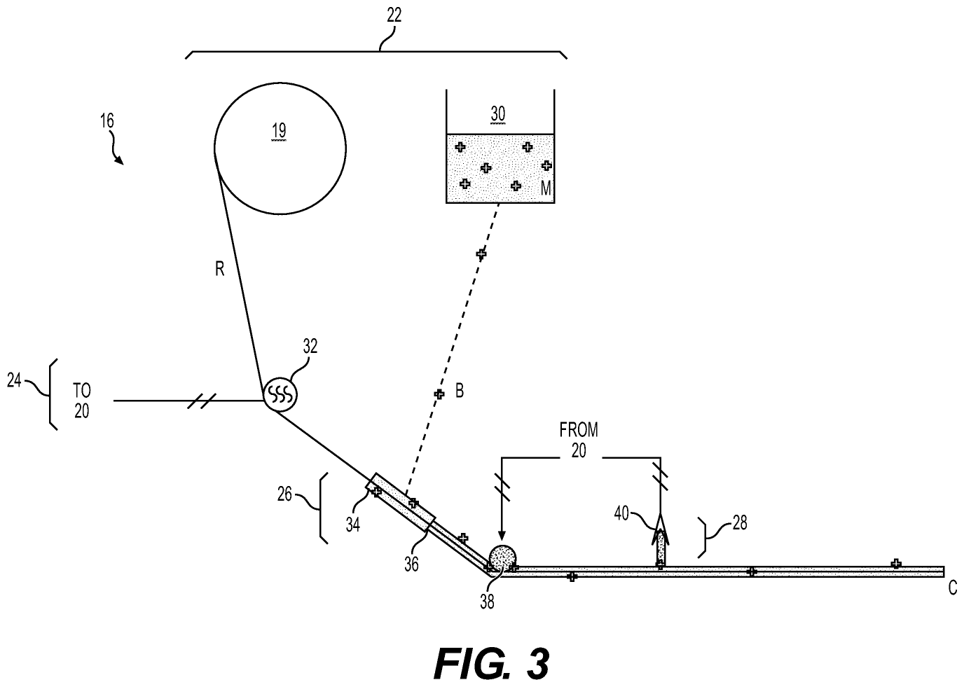

Head 16 may be configured to receive or otherwise contain a matrix (shown as M in FIG. 3) that, together with a continuous reinforcement (shown as R in FIG. 3), make up the composite material C discharging from head 16. The matrix may include any type of material that is curable (e.g., a liquid resin, such as a zero-volatile organic compound resin, a powdered metal, etc.). Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more.

In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16 and pushed or pulled out of head 16 along with one or more continuous reinforcements. In some instances, the matrix inside head 16 may benefit from being kept cool, dark, and/or pressurized (e.g., to inhibit premature curing or otherwise obtain a desired rate of curing after discharge). In other instances, the matrix may need to be kept warm and/or light for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, ribbons, socks, sheets and/or tapes of continuous material) and, together with the reinforcements, make up a portion (e.g., a wall, a floor, a ceiling, infill, support, etc.) of composite structure 12. The reinforcements may be stored within (e.g., on one or more separate internal creels 19) or otherwise passed through head 16 (e.g., fed from one or more external spools—not shown). When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry reinforcements, and/or reinforcements that are already exposed to the matrix (e.g., pre-impregnated reinforcements) may be transported into head 16 in any manner apparent to one skilled in the art.

In some embodiments, a filler material may be mixed with the matrix before and/or after the matrix coats the continuous reinforcements. The filler material may be selected to adjust a characteristic of the matrix and/or resulting composite material. For example, FIG. 3 illustrates an application where an energy blocking material (shown as B) has been mixed or otherwise added into the matrix (e.g., before and/or after the matrix wets the reinforcement). As will be explained in more detail below, the blocking material may be used to selectively block cure energy that would otherwise initiate premature curing of a matrix that is curable in the presence of electromagnetic energy (e.g., light). This may be particularly useful when the reinforcements coated with the matrix are at least partially transparent and unable to significantly block the energy themselves. In these applications, the energy blocking material may be, for example, chopped fibers (e.g., carbon or other fibers that are partially or substantially opaque to the cure energy), milled fibers, nanoparticles, etc. By blocking at least some of the cure energy with the blocking material, curing of the composite material may be specifically tailored for different applications.

As will be explained in more detail below, one or more cure enhancers (e.g., a UV light, an ultrasonic emitter, a laser, a heater, a catalyst dispenser, and/or another source of positive cure energy) may be mounted proximate (e.g., within, on, or adjacent) head 16 and configured to enhance a cure rate and/or quality of the matrix as it discharges from head 16. The cure enhancer(s) may be controlled to selectively expose portions of structure 12 to the cure energy (e.g., to UV light, electromagnetic radiation, vibrations, heat, a chemical catalyst, etc.) during material discharge and the formation of structure 12. The cure energy may trigger a chemical reaction to occur within the matrix, increase a rate of the chemical reaction, sinter the matrix, harden the matrix, or otherwise cause the matrix to cure as it discharges from head 16. The amount of energy produced by the cure enhancer(s) may be sufficient to cure the matrix before structure 12 axially grows more than a predetermined length away from head 16. In one embodiment, structure 12 is at least partially cured before the axial growth length becomes equal to an external diameter of the composite material C.

The matrix, filler, and/or reinforcement may be discharged from head 16 via one or more different modes of operation. In a first exemplary mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is being pulled from head 16 with the reinforcement, the resulting tension in the reinforcement may increase a strength of structure 12 (e.g., by aligning the reinforcements, inhibiting buckling, distributing loading, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, a surface of structure 12, etc.). For example, at the start of structure formation, a length of matrix-impregnated reinforcement may be pulled and/or pushed from head 16, deposited onto the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of or in addition to head 16 being moved away from the anchor.

A controller 20 may be provided and communicatively coupled with support 14, head 16, and any number of the cure enhancer(s). Each controller 20 may embody a single processor or multiple processors that are specially programmed or otherwise configured via software and/or hardware to control an operation of system 10. Controller 20 may further include or be associated with a memory for storing data such as, for example, design limits, performance characteristics, operational instructions, tool paths, and corresponding parameters of each component of system 10. Various other known circuits may be associated with controller 20, including power supply circuitry, signal-conditioning circuitry, solenoid driver circuitry, communication circuitry, and other appropriate circuitry. Moreover, controller 20 may be capable of communicating with other components of system 10 via wired and/or wireless transmission.

One or more maps may be stored in the memory of controller 20 and used by controller 20 during fabrication of structure 12. Each of these maps may include a collection of data in the form of lookup tables, graphs, and/or equations. In the disclosed embodiment, controller 20 may be specially programmed to reference the maps and determine movements of head 16 required to produce the desired size, shape, and/or contour of structure 12, and to responsively coordinate operation of support 14, additions of the blocking particles, operation of the cure enhancer(s), and other components of head 16.

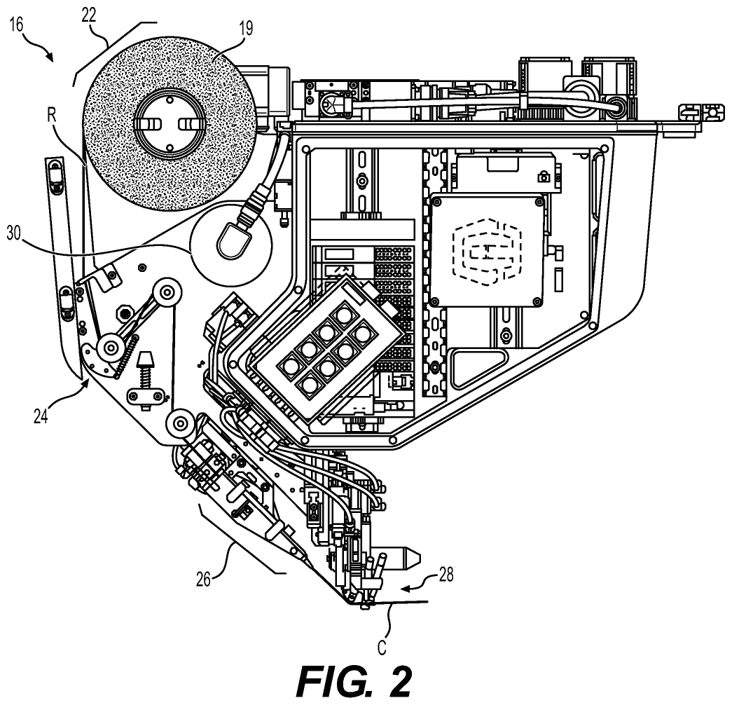

An exemplary head 16 is disclosed in greater detail in FIGS. 2 and 3. As can be seen in these figures, head 16 may include different components that cooperate to form, discharge and cure the composite material C. These components may include, among other things, a supply module 22, a conditioning module 24, a wetting module 26, and a compacting/curing module 28. Conditioning module 24 may be located between (i.e., relative to passage of the continuous reinforcement through head 16) supply module 22 and wetting module 26. Compacting/curing module 28 may be located downstream of wetting module 26. As will be described in more detail below, the reinforcement may pay out from module 22, pass through and be conditioned by module 24, and thereafter be wetted with matrix in and discharged through module 26. After discharge, the matrix-wetted reinforcement may be selectively compacted and/or cured by module 28.

As shown in FIG. 3, module 22 may include both a supply of reinforcement (i.e., creel 19) and a supply 30 of matrix. In some applications, the reinforcement may be generally opaque to cure energy generated by module 28 (e.g., blocking more than 50% of the energy). These fibers may include, for example, carbon fibers. In other applications, the reinforcement may be generally transparent to the cure energy (e.g., passing more than 50% of the energy). These fibers may include, for example, glass fibers (i.e., fiberglass). In these and other applications, the matrix may be a snap-curing (e.g., thermoset) matrix, which is triggered to chemically cross-link when exposed to a threshold dose of the cure energy (e.g., UV light).

During fabrication of structures 12 using generally transparent reinforcements, an amount of generally opaque filler material may be selectively added to the matrix to regulate characteristics of the composite material during energy exposure. These characteristics may include an intensity and/or amount of the UV light required to initiate the cross-linking, a temperature induced within the matrix prior to and/or during cross-linking, a time duration required to achieve a threshold level of cross-linking (e.g., to complete cross-linking of 70% or more of the matrix molecules), a void content resulting in the composite material, etc. The filler material may be manually and/or automatically added into the matrix prior to loading into supply 30 (e.g., prior to loading into head 16) and/or added into supply 30 prior to or at start of a fabrication event, at different times during the fabrication event (e.g., in differing amounts), and/or continuously throughout the fabrication event. It is contemplated that the filler material could additionally or alternatively be mixed into the matrix at a location within module 26, if desired. Although not shown in detail, module 22 may additionally include subcomponents that function to deliver the reinforcements and matrix from creel 19 and supply 30 to conditioning module and/or wetting module 26. These components may include, for example, an actuator (e.g., a motor) to drive rotation of creel 19, a pump and/or valve to regulate flow from supply 30, a mixer, a doser, one or more conduits, sensors, etc. Controller 20 may be in communication with one or more of these components and configured to coordinate their respective operations and achieve desired outcomes.

The amount of filler material added into the matrix, in some applications, may be related to a desired temperature of the matrix to be achieved prior to, during, and/or after curing when exposed to energy by module 28. That is, while a particular dose of UV light generated by module 28 may be intended to trigger cross-linking of photo-initiated matrix molecules (a.k.a., photo-initiators), exposure to more UV energy beyond the required dose may increase the temperature of the matrix. The filler materials allow an increase in UV intensity (and therefore thermal energy), while keeping the UV dose received by the photo-initiators relatively the same (i.e., because the filler absorbs the excess UV energy). The increase in temperature during cross-linking may facilitate a greater amount of cross-linking. As the amount of filler material within the matrix increases, a greater amount of energy exposure (and a corresponding higher temperature) may be achieved within the matrix for the same dosage of energy received by the photo-initiators. This may reduce a time required to achieve complete cross-linking (e.g., greater than about 70% of a theoretical maximum amount of cross-linking), increase an amount of cross-linking, lower a void content of the matrix prior to cross-linking, improve granularity in dosage control (e.g., because of a higher range of working intensities), decrease a viscosity of the matrix, improve wetting of the continuous reinforcement, and/or provide for other advantages. In one embodiment, the amount of filler added into the matrix may be selected to cause the temperature of the matrix to increase to about 60-100% (e.g., 80-90%) of a temperature at which the matrix will exotherm (e.g., up to about 100° C.). In some applications, the amount of filler mixed into the matrix may be pulled by controller 20 from the maps stored in memory (e.g., based on lab-tested relationships of filler type/amount, energy exposure, matrix type, reinforcement type, and/or temperature in a feedforward control algorithm) or may be pre-programmed into the machine code using tool pathing software. In other applications, however, the amount of filler may alternatively or additionally be mixed into the matrix based on feedback (e.g., based on a sensed temperature achieved via addition of the filler material within module 26 and/or 28).

It can be difficult, in some applications, to accurately and/or efficiently regulate a temperature (and corresponding enhancements) of the matrix via use of the filler material. Accordingly, conditioning module 24 may be configured to supplement or replace the use of the filler material for purposes of temperature control. For example, conditioning module 24 may include, among other things, a heating element 32, which is configured to selectively heat the continuous reinforcements before the reinforcements enter module 26 and are wetted with the matrix. Heating element 32 may include any type of device known in the art. For example, heating element 32 could include a heated redirect (e.g., a pully or bearing surface) over which the reinforcement passes, a fan/element combination that directs a flow of heated air towards the reinforcement, a power source that passes a resistive current directly through the reinforcement, an infrared element placed near the reinforcement, etc. Heating element 32 may be used to locally heat the reinforcement up to the 80-90% level discussed above, prior to the reinforcement being wetted with matrix. This may promote wicking of the matrix into and throughout the reinforcement, while also providing some or all of the other enhancements discussed above. In addition, the local heating of the reinforcement may require less energy and, therefore, be more efficient than utilizing the filler material and increasing cure dosing to achieve similar temperatures.

Wetting module 26 may be a monolithic or multi-part subassembly configured to separately receive the matrix, filler material, and/or reinforcement, and to discharge the composite material including at least the matrix coated reinforcement (i.e., with or without the filler material). In some embodiments, module 26 may include one or more nozzles (e.g., an entrant nozzle 34 and an exit nozzle 36). These nozzles may define one or more internal chambers in which the reinforcement is at least partially (e.g., completely) wetted with the matrix. In addition, the exit nozzle 36, in some applications, may have a cross-sectional area sized and/or shaped to provide a desired ratio of fiber-to-matrix in the composite material existing module 26. Although not shown, one or more sensors (e.g., temperature sensors, pressure sensors, tension sensors, etc.) may be associated with module 26 and configured to generate feedback used to regulate operation of module 22 and/or module 24.

An exemplary module 28 is illustrated in FIGS. 2 and 3. As shown in these figures, module 28 may be broken down into at least two subassemblies. These subassemblies include a primary compaction/curing assembly 38 and a trailing curing assembly 40. These subassemblies may be completely independent from each other or connected to move and/or operate together. One or both of subassemblies 38 and 40 may be biased toward the composite material discharging from module 26.

Assembly 38 may include components that cooperate to compact the discharging material. In one embodiment, only assembly 38 provides compaction to the discharging material.

In another embodiment, both assemblies 38 and 40 provide compaction, but the amount of compaction provided by assembly 38 is greater (e.g., 4-5 times greater) than the amount of compaction provided by assembly 40. For example, assembly 40 may provide only about 0.5-1.0 (e.g., 0.9N) of compaction, while assembly 38 may provide about 1-3N (e.g., 2N) of compaction. In yet another embodiment, both assemblies 38 and 40 provide compaction, but the amount of compaction provided by assembly 40 is greater (e.g., about 2-3 times greater).

In one example, assembly 38 includes a roller that slides and/or rolls over the discharging material to provide the compacting pressure on the material. In another example, assembly 38 includes a ski, shoe, skid or wiper that slides over the discharging material, or a foot that only presses against the material at a single tacking location (i.e., without significant movement along the material).

Assembly 38, in some applications, may selectively expose the matrix in the discharging material to cure energy at the same time that the material is being compacted by assembly 38. This cure energy may function only to heat the matrix (e.g., without triggering significant cross-linking), to trigger only a tacking amount of curing (e.g., an amount less than complete curing), or to cause complete curing of the matrix. Assembly 38 may be activated anytime material is discharging from module 26 or only at particular times. For example, assembly 38 may only be activated in some applications where a low-level of cure energy is required. This may include, for example, only during a tacking event (a startup event in which a loose end of the discharging material is to be tacked to an adjacent surface), only during discharge of the material along a straight trajectory, or during both the tacking and straight-trajectory discharging events. In general, the amount of energy generated by assembly 38 and/or directed from assembly 38 into the discharging material may be less than the amount of energy generated by assembly 40 and/or directed from assembly 40 into the discharging material. It is contemplated that assembly 38 may be activated only at times when assembly 40 is deactivated (and vice versa) or activated simultaneously, as desired. The cure energy generated by assembly 38 may be directed through the associated compacting mechanism (e.g., through the roller, ski, shoe, skid, wiper, and/or foot) and/or to a location trailing the compacting mechanism. It should be noted that assembly 38 may be capable of compacting the discharging material without simultaneously curing the material, if desired.

Assembly 40 may be configured to expose the discharging material to a higher-level of cure energy (e.g., 1.25-5 times higher than assembly 38) that at least triggers cross-linking of the matrix. Although assembly 40 may be capable of also compacting the discharging material (e.g., simultaneous to curing), it is contemplated that assembly 40 may primarily be configured to expose the material energy without applying pressure the material. In these applications, assembly 40 may simply embody a source of cure energy and/or a transmitter (e.g., a conduit) or optic that directs, focuses or otherwise conditions the cure energy received from a remote source. Assembly 40 may trail behind assembly 38, such that the material being exposed to energy from assembly 40 has already been compacted by assembly 38. In some applications, assembly 40 may only be activated during fabrication events requiring high levels of cure energy. These events may include, for example, high-speed discharge events and/or discharge along a cornering trajectory. It is contemplated that assembly 40 may be used alone during these events or used together with assembly 38, as desired.

### INDUSTRIAL APPLICABILITY

The disclosed system may be used to manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail with reference to FIGS. 1-3.

At a start of a manufacturing event, information regarding a desired structure 12 may be loaded into system 10 (e.g., into controller 20 that is responsible for regulating operations of support 14 and/or head 16). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement/filler stipulations, compaction requirements, curing requirements, etc. It should be noted that this information may alternatively or additionally be loaded into system 10 at different times and/or continuously during the manufacturing event, if desired.

Based on the component information, one or more different reinforcements and/or matrixes may be selectively loaded into head 16. For example, one or more supplies of reinforcement may be loaded onto creel 19 of module 22, and matrix (with or without filler) may be placed into supply 30.

The reinforcements may then be threaded through head 16 prior to start of the manufacturing event. Threading may include passing the reinforcement from module 22 around, over, and/or through module 24. The reinforcement may then be threaded through module 26 and wetted with matrix. The wetted reinforcement may then pass under module 28, and module 28 may thereafter press the wetted reinforcement against an underlying layer. After threading is complete, head 16 may be ready to discharge matrix-coated reinforcements.

At a start of a discharging event, one (e.g., only assembly 38) or both of assemblies 38, 40 may be activated to anchor a loose end of the wetted reinforcement to an adjacent (e.g., underlying) surface. Head 16 may thereafter be moved away from the point of anchor to cause the reinforcement to be pulled out of head 16. During this motion, one (e.g., only assembly 40) or both of assemblies 38, 40 may be activated to at least partially cure the discharging material. This may continue until discharge is complete.

During discharge of the wetted reinforcements from head 16, module 28 may move (e.g., slide and/or roll) over the reinforcements. A pressure may be applied against the reinforcements by one (e.g., only subassembly 38) or both of subassemblies 38 and/or 40, thereby compacting the material. One (e.g., only subassembly 40) or both of subassemblies 38 and/or 40 may remain active during material discharge from head 16 and during compacting, such that at least a portion of the material is cured and hardened enough to remain tacked to the underlying layer and/or to maintain its discharged shape and location. In some embodiments, a majority (e.g., all) of the matrix may be cured by exposure to energy from one (e.g., only subassembly 40) or both of Subassemblies 38 and 40.

It should be noted that the amount of cure energy generated by module 28 may be variable. For example, the energy could be generated at levels that are related to other parameters (e.g., travel speed, trajectory, discharging event, etc.) of head 16. The levels may include a low-level during which only subassembly 38 is activated, a midlevel during which only subassembly 40 is active, and a high-level during which both subassemblies 38 and 40 are active. Each of subassemblies 38 and 40 may be independently activated or activated simultaneously in a cooperative manner.

The component information may be used to control operation of system 10. For example, the reinforcements may be discharged from head 16 (along with the matrix and filler), while support 14 selectively moves head 16 in a desired manner during curing, such that an axis of the resulting structure 12 follows a desired trajectory (e.g., a free-space, unsupported, 3-D trajectory). In addition, module 22 may be carefully regulated by controller 20 such that the reinforcement is wetted with a precise and desired amount of the matrix. For example, based on a feed rate of the reinforcement through head 16, controller 20 may selectively increase or decrease operation of module 22 to provide a corresponding feed rate of matrix and/or filler to module 26. This feed rate may be trimmed, in some embodiments, based on sensory feedback. In this way, regardless of the travel speed of head 16, a desired ratio of matrix-to-reinforcement and/or amount of filler may always be maintained.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A method of additively manufacturing a structure, comprising:
discharging a composite material, including a reinforcement and a matrix, from a print head;
moving the print head during discharging to form the structure from the composite material;
exposing the composite material during discharging to a cure energy to trigger the matrix to harden; and
selectively adding a filler to the composite material to cause the composite material to increase a temperature achieved when the composite material is exposed to the cure energy.

2. The method of claim 1, wherein the filler is configured to block at least some of the cure energy from the matrix.

3. The method of claim 2, wherein the filler is configured to block at least 50% of the cure energy from the matrix.

4. The method of claim 1, wherein selectively adding the filler includes adding an amount of the filler to cause the composite material to warm to a temperature that is 80-90% of a temperature at which the matrix will exotherm.

5. The method of claim 1, wherein the filler is at least one of a chopped fiber, a fiber particle or a nanoparticle of fiber.

6. The method of claim 5, wherein the filler is at least one of a chopped carbon fiber, a carbon fiber particle or a nanoparticle of carbon fiber.

7. The method of claim 1, wherein selectively adding the filler includes:
adding the filler to the matrix; and
thereafter wetting the reinforcement with the matrix.

8. The method of claim 7, further including detecting a temperature of the composite material, wherein adding the filler to the matrix includes adding the filler to the matrix in response to the detected temperature.

9. The method of claim 7, further including heating the reinforcement prior to wetting the reinforcement with the matrix.

10. A method of additively manufacturing a structure, comprising:
heating a reinforcement at a location inside of a print head;
wetting the heated reinforcement with a matrix to form a composite material;
discharging the composite material from the print head;
moving the print head during discharging to form the structure; and
exposing the discharging composite material to a cure energy to trigger the matrix to harden.

11. The method of claim 10, wherein heating the reinforcement includes heating the reinforcement to a temperature that is 80-90% of a temperature at which the matrix will exotherm.

12. The method of claim 10, wherein heating the reinforcement includes passing the reinforcement over a heated redirected inside of the print head.

13. A method of additively manufacturing a structure, comprising:
discharging a composite material, including a reinforcement and a matrix, from print head;
moving the print head during discharging to form the structure;
exposing the composite material to a first cure energy at a first location during discharging; and
exposing the composite material to a second cure energy at a second location downstream of the first location,
wherein the second cure energy is greater than the first cure energy.

14. The method of claim 13, further including moving a compactor against the discharging composite material at the first location.

15. The method of claim 14, wherein exposing the composite material to the first cure energy includes directing the first cure energy through the compactor.

16. The method of claim 13, wherein:
exposing the composite material to the first cure energy includes exposing the composite material to only the first cure energy during a first fabrication event; and
exposing the composite material to the second cure energy includes exposing the composite material to only the second cure energy during a second fabrication event.

17. The method of claim 16, further including exposing the composite material to both the first and second cure energies during a third fabrication event.

18. The method of claim 16, wherein:
the first fabrication event is a tacking event; and
the second fabrication event is a cornering event.

19. The method of claim 13, wherein:
exposing the composite material to the first cure energy includes exposing the composite material to only the first cure energy during a first fabrication event; and
exposing the composite material to the second cure energy includes exposing the composite material to both the first cure energy and the second cure energy during a second fabrication event.

20. A system for additively manufacturing a structure, comprising:
a print head configured to discharge a composite material, including a reinforcement and a matrix;
a support configured to move the print head during discharging to form the structure from the composite material;
a cure enhancer configured to expose the composite material during discharging to a cure energy to trigger the matrix to harden; and
a supply configured to selectively add a filler to the composite material to cause the composite material to increase a temperature achieved when the composite material is exposed to the cure energy.
